(19) United States
(12) Patent Application Publication
(10) Pub. No.: US 2012/0013747 A1
(43) Pub. Date: Jan. 19, 2012

(54) IMAGE TESTING METHOD OF IMAGE PICKUP DEVICE AND IMAGE TESTING APPARATUS USING SUCH METHOD

(75) Inventors: Szu-Hao Lyu, Taipei (TW); Chien-Nan Yu, Taipei (TW)

(73) Assignee: PRIMAX ELECTRONICS LTD., Taipei (TW)

(21) Appl. No.: 12/908,635

(22) Filed: Oct. 20, 2010

(30) Foreign Application Priority Data
Jul. 16, 2010 (TW) 099123429

(51) Int. Cl. H04N 17/00

(52) U.S. Cl. 348/187; 348/E17.002

(57) ABSTRACT

An image testing method of an image pickup device and an image testing apparatus using such a method are provided. The image testing apparatus is in communication with the image pickup device. The image testing apparatus includes an image processing program, a multi-core processing unit and a storage unit. The image processing program is used for segmenting the main image, which is acquired by the image pickup device, into plural sub-image blocks, and transmitting the sub-image blocks to respective threads. The multi-core processing unit is used for synchronously executing the threads, thereby synchronously analyzing imaging quality of respective sub-image blocks. The storage unit is used for storing analyzing results of respective sub-image blocks. The analyzing results of respective sub-image blocks stored in the storage unit are combined together by the multi-core processing unit, thereby acquiring the imaging quality of the main image.

### FIELD OF THE INVENTION

The present invention relates to an image testing method, and more particularly to an image testing method of an image pickup device. The present invention also relates to an image testing apparatus using such an image testing method.

### BACKGROUND OF THE INVENTION

With increasing development of high technology industries, computers and their peripheral devices become essential electronic apparatuses in our daily lives. Image pickup devices such as web cameras or digital cameras are widely used in computer systems to take photographs or record video data in order to provide convenience to the human beings. For example, after the user has visited customers or taken part in a meeting, the basic information associated with the business cards of the customers or conferees needs to be filed in order to quickly search the basic information in the future. For convenience, after the image of the business card is acquired by the image pickup device, the image data can be immediately recognized or filed by associated software or hardware components of the notebook computer. As such, the information associated with the business card is digitized. Moreover, it is also convenient to acquire the images of other documents having a size similar to the business card by the image pickup device of the notebook computer. The document having a size similar to the business card includes but is not limited to a photograph, a credit card, a debit card, an identification card, an envelope, a postcard, a ticket card, a notepaper, a bookmark and the like.

For assuring the desired performance of the image pickup device, an image testing procedure should be performed on every image pickup device before the image pickup device is introduced into the market. The image testing procedure may increase the reliability of producing the image pickup device. That is, after an image pickup device is assembled, the image pickup device is used to shoot some specified test patterns. By using an image testing apparatus (e.g. a computer) and an image processing program thereof to analyze the images of the test patterns, the tester may judge whether the image pickup device is qualified. Generally, the images of the test patterns are analyzed in several items, including the blemish, particle, shading and/or uniformity of the image. If the image analyzing result indicates that the image shot by the image pickup device is unqualified, the image pickup device should be re-assembled or discarded.

The conventional image testing method, however, still has some drawbacks. For example, according to the conventional image testing method, an image is firstly acquired by an image pickup device and the whole image is then directly analyzed by an image testing apparatus in the production line. With increasing development of science and technology, the demand on the resolution of the image acquired by the image pickup device is gradually increased. In other words, during the process of analyzing the overall image, the image testing apparatus requests an increasing computing amount. As such, the process of analyzing the overall image is time-consuming, and it takes a long time to implement the image testing method.

Recently, another conventional image testing method has been disclosed. According to this image testing method, an image is firstly acquired by an image pickup device, and then the whole image is segmented into plural sub-image blocks. The plural sub-image blocks are successively analyzed by the image testing apparatus, and the analyzing results of respective sub-image blocks are combined together. In such way, the quality of the whole image will be realized. However, since the process of successively analyzing the plural sub-image blocks is also time-consuming, it takes a long time to implement the image testing method.

### SUMMARY OF THE INVENTION

The present invention provides an image testing method, and more particularly to an image testing method for testing an image shot by an image pickup device in a production line, thereby judging whether the image pickup device is qualified.

The present invention provides an image testing apparatus, and more particularly to an image testing apparatus having enhanced computing performance of implementing image analysis.

In accordance with an aspect of the present invention, there is provided an image testing method of an image pickup device for realizing imaging quality of a main image. The image testing method includes the following steps. Firstly, in a step (A), a test pattern is shot to obtain the main image. Then, in a step (B), the main image is segmented into plural sub-image blocks. In a step (C), by analyzing imaging quality of respective sub-image blocks, analyzing results of respective sub-image blocks are acquired. Afterwards, in the step (D), the analyzing results of the sub-image blocks are combined together, thereby realizing the imaging quality of the main image.

In an embodiment, the step (C) comprises sub-steps of (C1) transmitting the plural sub-image blocks to respective threads, (C2) synchronously executing the threads according to a multi-thread technology, and (C3) detecting blemish, particle, shading and/or uniformity about the sub-image blocks, thereby acquiring the analyzing results of respective sub-image blocks.

In an embodiment, the uniformity includes brightness uniformity or color uniformity.

In an embodiment, in the step (B), an overlapping region is formed between any two adjacent sub-image blocks.

In accordance with another aspect of the present invention, there is provided an image testing apparatus in communication with an image pickup device for realizing imaging quality of a main image, which is acquired by the image pickup device. The image testing apparatus includes an image processing program, a multi-core processing unit and a storage unit. The image processing program is used for segmenting the main image into plural sub-image blocks, and transmitting the sub-image blocks to respective threads. The multi-core processing unit is used for synchronously executing the threads, thereby synchronously analyzing imaging quality of respective sub-image blocks. The storage unit is used for storing analyzing results of respective sub-image blocks. The analyzing results of the sub-image blocks stored in the storage unit are combined together by the multi-core processing unit, thereby acquiring the imaging quality of the main image.

In an embodiment, the analyzing results of the sub-image blocks are obtained by detecting blemish, particle, shading and/or uniformity about respective sub-image blocks.

In an embodiment, the uniformity includes brightness uniformity or color uniformity.

In an embodiment, an overlapping region is formed between any two adjacent sub-image blocks.

In an embodiment, the image pickup device is a web camera.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic block diagram illustrating an image testing apparatus according to an embodiment of the present invention;

FIG. 2 is a flowchart illustrating an image testing method for testing an image pickup device according to an embodiment of the present invention; and

FIG. 3 is a schematic diagram illustrating an image segmentation operation performed on the image that is shot by the image pickup device according to an embodiment of the present invention.

### DETAILED DESCRIPTION OF THE PREFERRED EMBODIMENT

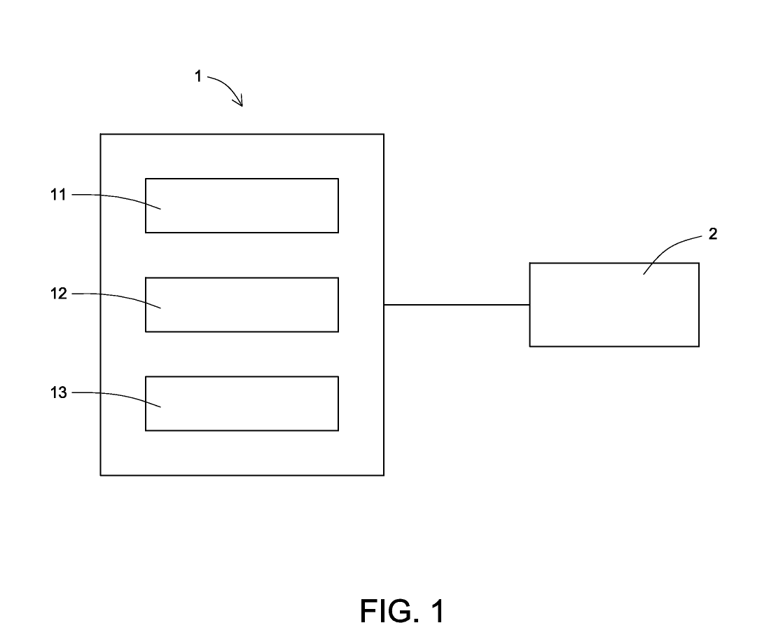

FIG. 1 is a schematic block diagram illustrating an image testing apparatus according to an embodiment of the present invention. In the process of fabricating an image pickup device 2, a testing procedure is performed before the image pickup device 2 is introduced into the market. That is, after the image pickup device 2 is assembled, the image pickup device 2 is in communication with the image testing apparatus 1. During the testing procedure is performed, the image pickup device is operated to shoot some specified test patterns. The image data of the test patterns are then analyzed by the image testing apparatus 1. According to the analyzing result of the image data, the user may judge whether the image pickup device 2 is a qualified product to be introduced to the market. As shown in FIG. 1, the image testing apparatus 1 comprises an image processing program 11, a multi-core processing unit 12 and a storage unit 13. In this embodiment, an example of the image testing apparatus 1 includes but is not limited to a computer, and an example of the image pickup device 2 includes but is not limited to a web camera.

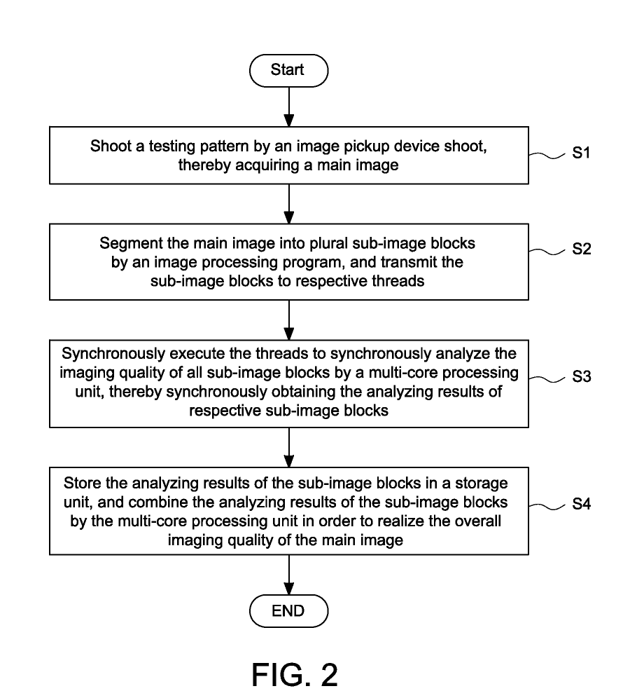

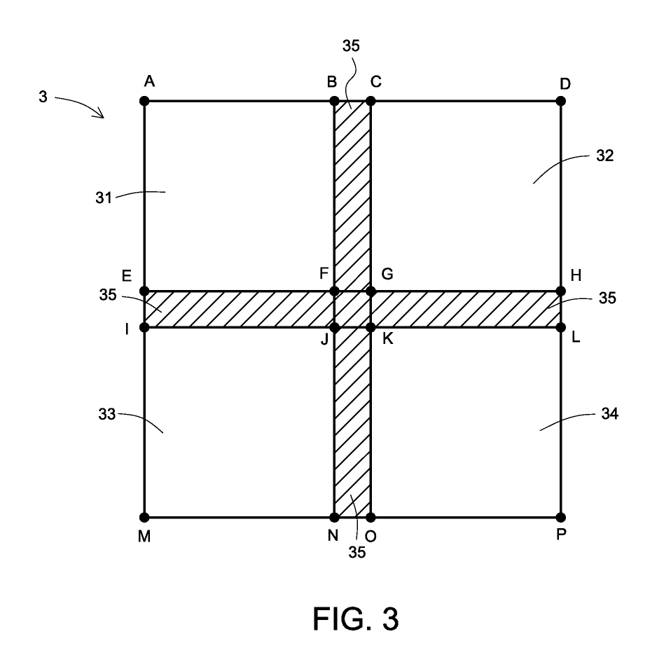

Hereinafter, the operations of the present invention will be illustrated with reference to FIGS. 2 and 3. FIG. 2 is a flowchart illustrating an image testing method for testing an image pickup device according to an embodiment of the present invention. FIG. 3 is a schematic diagram illustrating an image segmentation operation performed on the image that is shot by the image pickup device according to an embodiment of the present invention.

In the step S1, the image pickup device 2 is operated to shoot a testing pattern, thereby acquiring a main image 3.

In the step S2, the image processing program 11 is executed to segment the main image 3 into plural sub-image blocks. For example, the plural sub-image blocks comprises a first sub-image block 31 (i.e. the block defined by four points A, C, K and I), a second sub-image block 32 (i.e. the block defined by four points B, D, L and J), a third sub-image block 33 (i.e. the block defined by four points E, G, O and M) and a fourth sub-image block 34 (i.e. the block defined by four points F, H, P and N). The sub-image blocks 31, 32, 33 and 34 are transmitted to respective threads. Each of the threads is used to process the task of analyzing a corresponding sub-image block. That is, all of the threads are executed in the step S3 to analyze the respective sub-image blocks.

Moreover, for avoiding erroneously judging the boundary of each of the sub-image blocks 31, 32, 33 and 34, during the image processing program 11 is executed to segment the main image 3 into the plural sub-image blocks, an overlapping region 35 is formed between any two adjacent sub-image blocks. This embodiment is illustrated by referring to four sub-image blocks. It is noted that the number of sub-image blocks and the distribution of the overlapping regions may be modified or altered according to the practical requirements.

In the step S3, the multi-core processing unit 12 synchronously executes the threads in order to synchronously analyze the imaging quality of all sub-image blocks 31˜34. In other words, the analyzing results of the sub-image blocks 31˜34 can be obtained at the same time according to a multi-thread technology.

Moreover, the image analysis on the sub-image blocks 31˜34 may include several test items (e.g. blemish, particle, shading and/or uniformity). The uniformity includes color uniformity or brightness uniformity. The detecting algorithm about blemish detection, particle detection, shading detection or uniformity detection is known in the art, and is not redundantly described herein.

In this embodiment, according to the multi-thread technology, the multi-core processing unit 12 has the capability of executing at least one thread at the same time. In comparison with the single-core processing unit having the function of executing a single thread once, the computing performance of implementing the detecting algorithm by the multi-core processing unit 12 is largely enhanced.

In the step S4, the analyzing results of the sub-image blocks 31˜34 are stored in the storage unit 13. In addition, by the multi-core processing unit 12, the analyzing results of the sub-image blocks 31˜34 stored in the storage unit 13 are combined together. As such, the overall imaging quality of the main image 3 is acquired.

As previously described in the prior art, the conventional image testing method analyzes the whole image that is acquired by the image pickup device once or successively analyzes the plural sub-image blocks segmented from the main image. In other words, the conventional image testing method is time-consuming and has deteriorated computing performance. On the other hand, according to the image testing method of the present invention, the main image 3 acquired by the image pickup device 2 is firstly segmented into plural sub-image blocks 31˜34, and the plural sub-image blocks 31˜34 are synchronously analyzed by the image testing apparatus 1 according to the well-established multi-thread technology. As a consequence, the computing time of the image testing apparatus 1 will be shortened, and the producing efficiency and reliability of the image pickup device 2 will be enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image testing method of an image pickup device for realizing imaging quality of a main image, said image testing method comprising steps of:
(A) shooting a test pattern to obtain said main image;
(B) segmenting said main image into plural sub-image blocks;
(C) synchronously analyzing imaging quality of respective sub-image blocks, thereby acquiring analyzing results of respective sub-image blocks; and
(D) combining said analyzing results of said sub-image blocks together, thereby realizing said imaging quality of said main image.

2. The image testing method according to claim 1 wherein said step (C) comprises sub-steps:
(C1) transmitting said plural sub-image blocks to respective threads;
(C2) synchronously executing said threads according to a multi-thread technology; and
(C3) detecting blemish, particle, shading and/or uniformity about said sub-image blocks, thereby acquiring said analyzing results of respective sub-image blocks.

3. The image testing method according to claim 2 wherein said uniformity includes brightness uniformity or color uniformity.

4. The image testing method according to claim 1 wherein in said step (B), an overlapping region is formed between any two adjacent sub-image blocks.

5. An image testing apparatus in communication with an image pickup device for realizing imaging quality of a main image, which is acquired by said image pickup device, said image testing apparatus comprising:
an image processing program for segmenting said main image into plural sub-image blocks, and transmitting said sub-image blocks to respective threads;
a multi-core processing unit for synchronously executing said threads, thereby synchronously analyzing imaging quality of respective sub-image blocks; and
a storage unit for storing analyzing results of respective sub-image blocks,
wherein said analyzing results of said sub-image blocks stored in said storage unit are combined together by said multi-core processing unit, thereby acquiring said imaging quality of said main image.

6. The image testing apparatus according to claim 5 wherein said analyzing results of said sub-image blocks are obtained by detecting blemish, particle, shading and/or uniformity about respective sub-image blocks.

7. The image testing apparatus according to claim 6 wherein said uniformity includes brightness uniformity or color uniformity.

8. The image testing apparatus according to claim 5 wherein an overlapping region is formed between any two adjacent sub-image blocks.

9. The image testing apparatus according to claim 5 wherein said image pickup device is a web camera.
